(19) United States
(12) Patent Application Publication
(10) Pub. No.: US 2005/0197109 A1
(43) Pub. Date: Sep. 8, 2005

(54) System and method for controlling calling number identification presentation

(75) Inventor: In-Young Kim, Seoul (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/070,424

(22) Filed: Mar. 2, 2005

(30) Foreign Application Priority Data
Mar. 8, 2004 (KR) 15561/2004

(51) Int. Cl. H04B 1/38; H04M 1/00; H04M 3/42

(52) U.S. Cl. 455/415; 455/567

(57) ABSTRACT

Disclosed is a system and a method which can display a calling number desired by a user of a calling terminal on a called terminal in a mobile communication system. The mobile communication system included a calling terminal for transmitting an origination message which includes a phone number of a called terminal and a specific number input by its user; a mobile switching center for determining if the origination message includes the specific number when the origination message is received, sensing the specific number when the origination message includes the specific number, creating an alert message which includes a message corresponding to the specific number, and transmitting the alert message to the called terminal; and the called terminal for displaying the message included in the alert message when the alert message is received.

### PRIORITY

This application claims priority to an application entitled “System And Method For Controlling Calling Number Identification Presentation” filed in the Korean Intellectual Office on Mar. 8, 2004 and assigned Serial No. 2004-15561, the contents of which are incorporated herein by reference.

### BACKGROUND OF THE INVENTION

1. Field of the Invention

The present invention relates to a mobile communication system, and more particularly to a system and a method for controlling a presented calling number according to the necessity of a user of a calling terminal, when the calling number is presented on a called terminal.

2. Description of the Related Art

In general, a mobile communication system includes a mobile station (MS) that can communicate while moving, a base transceiver station (BTS) for performing communication with the mobile station by wireless communications, a base station controller (BSC) for controlling the base transceiver station, a mobile switching center (MSC) which is connected with the base station controller (BSC) and switches a call, and a home location register (HLR) which is connected with the mobile switching center (MSC) and stores the information of the subscribers. The mobile station communicates with the base transceiver station by wireless communications, and the mobile switching center performs a call switching function that connects an originating call to a called party during voice and data communication, so that the voice and/or data communication is achieved between a calling party and the called party.

Such a general mobile communication system provides a calling number identification presentation (hereinafter, simply referred to as “CNIP”) function, which presents information of a caller on a called terminal, as an option. It goes without saying that the CNIP function is a supplementary service which is provided to only the subscribers having registered for the CNIP function. In the following description, “a called subscriber” means a subscriber having registered for the CNIP function.

That is, when a caller having registered for the CNIP function generates a call, the phone number of the caller is unconditionally displayed on the terminal of a called subscriber having registered for the CNIP function. Then, the called subscriber sees the displayed calling number and may selectively try to communicate with the caller. That is, only if the called subscriber sees the displayed calling number and wishes to communicate, the called subscriber may respond to the call, so that it is possible to achieve selective communication.

Meanwhile, when the caller does not desire that the caller's calling number be made known to the called subscriber, a temporary calling number identification restriction service may be used. That is for example, when an originating call is transmitted with “*23#” attached thereto, a phrase “calling number identification restriction” is displayed on the called terminal. Therefore, according to the prior art, the caller can select only one of showing the caller's phone number to the called subscriber and not showing the caller's phone number.

Displaying a calling number as described above is achieved in such a manner that a service provider notifies the called terminal of the caller's phone number which has been stored in advance in a database. Therefore, when a caller cannot use his/her own terminal, there is no way of notifying a called subscriber of a phone number of the caller.

### SUMMARY OF THE INVENTION

Accordingly, the present invention has been made to solve at least the above-mentioned problems occurring in the prior art, and at least one object of the present invention is to provide a system and a method which can display a calling number desired by a user of a calling terminal on a called party's terminal.

To accomplish this object, in accordance with one aspect of the present invention, there is provided a mobile communication system including a calling terminal for transmitting an origination message which includes a phone number of a called terminal and a specific number input by its user; a mobile switching center for determining if the origination message includes the specific number when the origination message is received, sensing the specific number when the origination message includes the specific number, creating an alert message which includes a message corresponding to the specific number, and transmitting the alert message to the called terminal; and the called terminal for displaying the message included in the alert message when the alert message is received.

In accordance with another aspect of the present invention, there is provided a method for displaying a calling number in a mobile communication system which includes a calling terminal, a mobile switching center, and a called terminal, the method comprising the steps of transmitting, in the calling terminal, an origination message to the mobile switching center, the origination message including a phone number of the called party's terminal and a specific number input by its user; determining, in the mobile switching center, if the origination message includes the specific number when the origination message is received, sensing the specific number when the origination message includes the specific number for requesting a calling number change service, creating an alert message which includes a message corresponding to the specific number, and transmitting the alert message to the called terminal; and displaying, in the called terminal, the message included in the alert message when the alert message is received.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram showing a construction of a mobile communication system to which the present invention is applied;

FIG. 2 is a block diagram showing a construction of a mobile communication terminal to which the present invention is applied;

FIG. 3 is a flowchart showing processing procedures of a calling party's terminal, a mobile switching center, and a called terminal in a mobile communication system according to a first embodiment of the present invention; and

FIG. 4 is a flowchart showing processing procedures of a calling party's terminal, a mobile switching center, and a called terminal in a mobile communication system according to a second embodiment of the present invention.

### DETAILED DESCRIPTION OF THE PREFERRED EMBODIMENT

Hereinafter, one preferred embodiment of a system and a method for controlling calling number identification presentation according to the present invention will be described with reference to the accompanying drawings. In the following description of the present invention, a detailed description of known functions and configurations incorporated herein will be omitted when it may obscure the subject matter of the present invention.

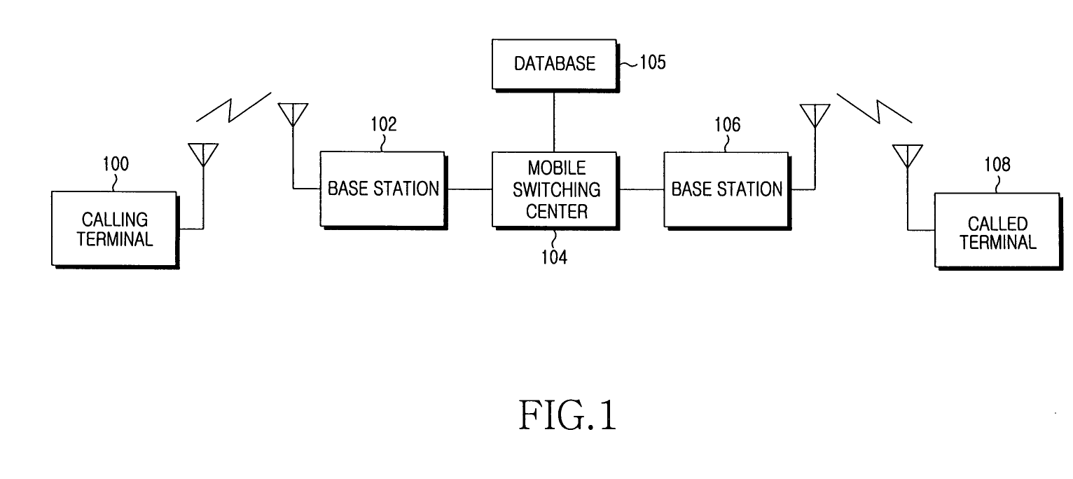

FIG. 1 is a block diagram showing a construction of a mobile communication system to which the present invention is applied.

First, components shown in FIG. 1 will be described. A mobile communication system includes mobile communication terminals such as a calling terminal 100 and a called terminal 108, base stations (BSs) 102 and 106, a mobile switching center 104, and a home location register shown as database 105. In the mobile communication system shown in FIG. 1, although not shown, each of the base stations (BSs) 102 and 106 includes a base transceiver station (BTS) and a base station controller (BSC). The mobile communication terminal has a specific number (a phone number) and is a portable terminal for a subscriber. The base stations 102 and 106, which are wireless stations, functions to communicate with the mobile communication terminals. The respective base stations 102 and 106 can transmit a wireless signal to a mobile communication terminal and receive a wireless signal from a mobile communication terminal in a wireless communication area. The base station controllers are located between the mobile switching center 104 and each of the base stations 102 and 104, control the base stations 102 and 106, and manage wireless resources. Also, the base station controllers control a hand-off function between the base station controllers and the base stations 102 and 106. The mobile switching center 104 stores the locations of the mobile communication terminals, sever profiles, etc., and performs a switching function to connect a channel, and thereby realizing communication. The home location register 105 is a database which stores the locations of the mobile communication terminals for the subscribers, the service profiles of the subscribers, and the service profile information of the subscriber, etc.

In a CDMA system having the above-mentioned construction, a control process for displaying a calling number desired by a user of the calling terminal on the called terminal (hereinafter, simply referred to as “desired calling number) will now be explained.

When the calling terminal 100 senses an input of a phone number for communication input by a user of the calling terminal 100 and an input of a call key, the calling terminal 100 transmits an origination message including the input phone number. Herein, the user of the calling terminal 100 inputs both a calling number desired to be displayed on the called terminal 108 and the phone number of the called terminal 108. Then, the calling terminal 100 transmits the origination message including the two numbers input by its user.

Then, the mobile switching center 104 receives the origination message and determines if the origination message includes a number for a calling number change service. As a result of the determination, when the origination message includes a desired calling number for the calling number change service, the mobile switching center 104 adds the desired calling number received from the calling terminal 100 into a record field, thereby creating an alert message. Herein, if an origination message includes a desired calling number for the calling number change service may be decided by determining if a first delimiter “*” for representing the beginning of an input of the desired calling number, a second delimiter “#” for representing the completion of the input of the desired calling number, and the desired calling number are included. Such delimiters may be preset and changed by a service provider. In addition, the mobile switching center 104 transmits the created alert message to the called terminal 108.

The called terminal 108 receives the alert message including the desired calling number, and displays the desired calling number included in the alert message.

In a WCDMA system having the construction as shown in FIG. 1, a control process for displaying a desired calling number, which is desired by a user of the calling terminal, on the called terminal will now be explained.

When a user of the calling terminal 100 inputs a phone number and a call key for communication, the calling terminal 100 determines if input data includes a request for the calling number change service. As a result of the determination, when the input data includes a request for the calling number change service, that is, when the input data includes the first delimiter “*” and the second delimiter “#” for representing the beginning and the completion of an input of a desired calling number, respectively, the calling terminal 100 records the input calling number in an optional field of a setup message. After this, the calling terminal 100 transmits the setup message including the desired calling number to the mobile switching center 104.

Then, the mobile switching center 104 receives the setup message and determines if the received setup message includes a desired calling number for the calling number change service. As a result of the determination, when the setup message includes a desired calling number, the mobile switching center 104 records a binary coded decimal (BCD) number of the calling party, that is, the desired calling number to be input by the user of the calling party, in a setup message to be transmitted to the called terminal 108. Then, the mobile switching center 104 transmits the setup message to the called terminal 108.

After this, the called terminal 108 receives the setup message including the desired calling number, and displays the BCD number of the calling party.

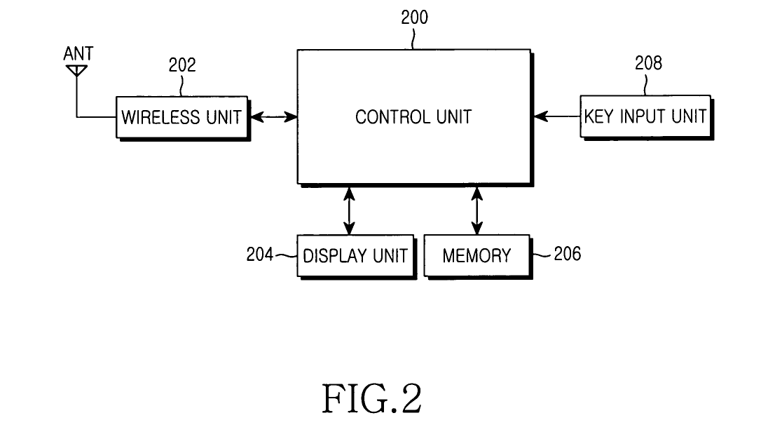

FIG. 2 is a block diagram showing a construction of a mobile communication terminal to which the present invention is applied. In FIG. 2, a control unit 200 is a block for processing and controlling voice, message and data communications. In addition to such general functions, the control unit 200 also controls the displaying a desired calling number according to the present invention as described below. A wireless unit 202 is controlled by the control unit 200. When the wireless unit 202 receives a frequency signal through an antenna (ANT), which is received through a wireless channel having a frequency band, the wireless unit 202 down-converts the received frequency signal to a predetermined band, and outputs the down-converted signal to the control unit 200 after classifying the down-converted signal according to kinds of data. The data, which is output from the wireless unit 202 to the control unit 200, may include letter data, a paging signal received through a paging channel, or a signaling signal. A memory 206 stores a program performed by the control unit 200 and temporarily stores data processed by the program. A key input unit 208 includes a plurality of numeral keys and function keys, and applies key data according to key inputs. A display unit 204 displays various states of the mobile communication terminal according to the control of the control unit 200. Such a mobile communication terminal may be used as the calling terminal 100 and/or the called terminal 108 according to the present invention.

The calling terminal 100 constructed with such a mobile communication terminal will now be described. Herein, the operations of the calling terminal 100 will be explained with regard to each case in which the calling terminal 100 is a CDMA terminal and a WCDMA terminal.

First, in a case in which the calling terminal 100 is a CDMA terminal, the operation of the calling terminal 100 is as follows. When a user inputs a phone number and a call key for communication through the key input unit 208, the control unit 200 senses them and transmits an origination message including the input number through the wireless unit 202. At this time, the user of the calling terminal 100 inputs the phone number of the called terminal 108 and the desired calling number which the user of the calling terminal 100 desires to display on the called terminal 108. The calling terminal 100 transmits the origination message including the number input by its user.

Second, in a case in which the calling terminal 100 is a WCDMA terminal, the operation of the calling terminal 100 is as follows. When a user inputs a phone number and a call key, the control unit 200 senses them, and determines if input data includes a request for the calling number change service. As a result of the determination, when the input data includes a request for the calling number change service, that is, when the input data includes the first delimiter “*” and the second delimiter “#” for representing the beginning and the completion of an input of the a desired calling number for presentation, respectively, the calling terminal 100 records the input calling number in an optional field of a setup message. After this, the calling terminal 100 transmits the setup message including the desired calling number through the wireless unit 202.

Meanwhile, the called terminal 108 constructed with such a mobile communication terminal as shown in FIG. 2 will now be described. In a case in which the called terminal 108 is a CDMA terminal, when the called terminal 108 receives an alert message including a desired calling number, the control unit 200 displays the desired calling number included in the alert message through the display unit 204.

In a case in which the called terminal 108 is a WCDMA terminal, when the called terminal 108 receives a setup message including a desired calling number, the control unit 200 displays a BCD number of the calling party.

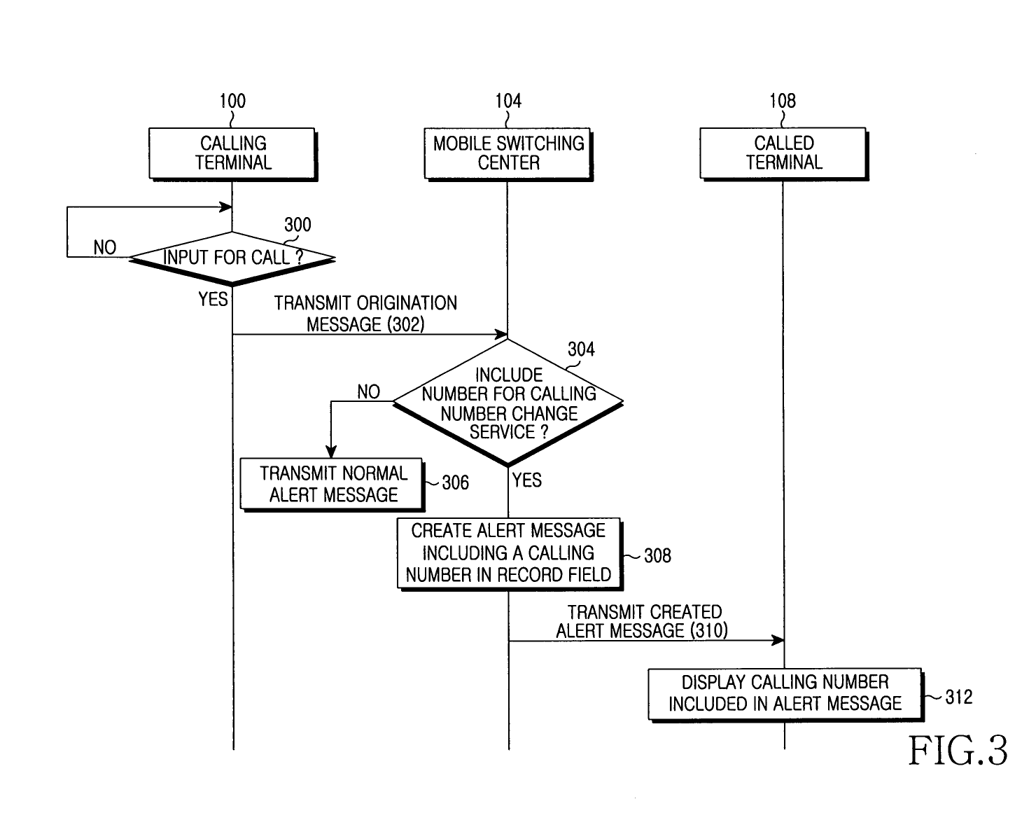

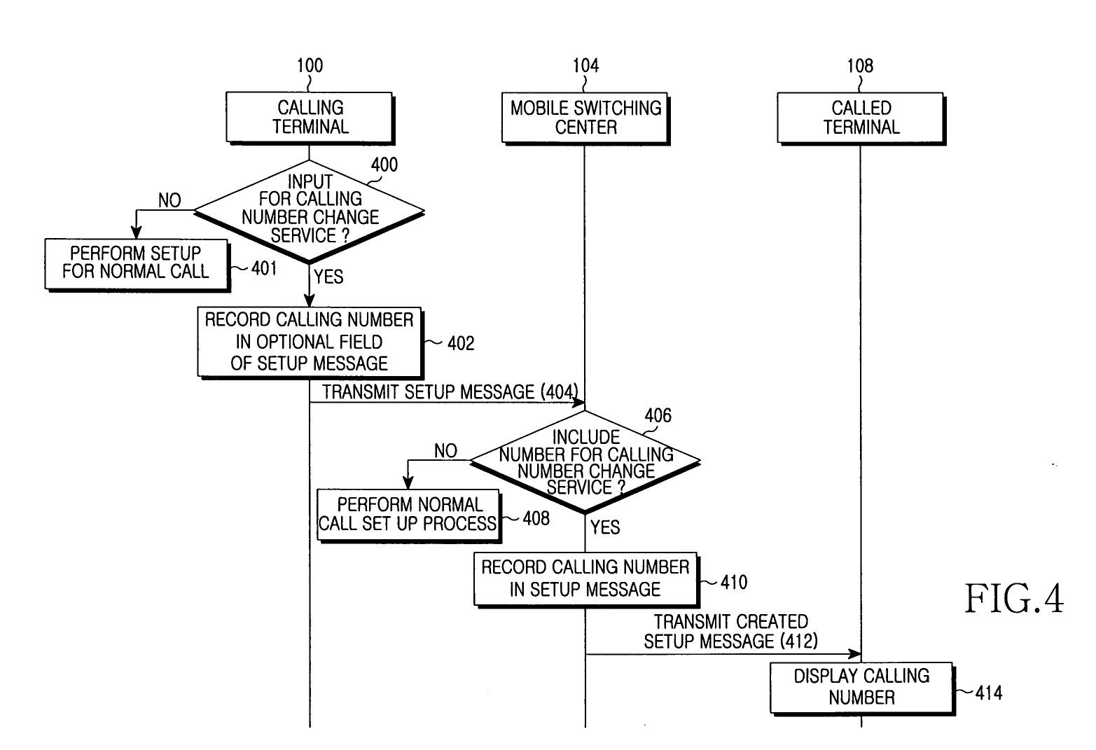

FIG. 3 is a flowchart showing processing procedures for a calling terminal, a mobile switching center, and a called terminal in a mobile communication system according to a first embodiment of the present invention. FIG. 4 is a flowchart showing processing procedures for a calling terminal, a mobile switching center, and a called terminal in a mobile communication system according to a second embodiment of the present invention. Herein, the first embodiment is an example in which the construction of the present invention is applied to the CDMA mobile communication system, and the second embodiment is an example in which the construction of the present invention is applied to the WCDMA mobile communication system.

In the following description, a description will be given for a method for displaying a calling number desired by a user of a calling terminal 100 on a called terminal 108 in a CDMA mobile communication system with reference to FIG. 3.

First, in step 300, when the calling terminal 100 senses the input of a phone number and the input of a call key performed by its user for communication, the calling terminal 100 transmits an origination message including the input number (step 302). At this time, the user of the calling terminal 100 inputs both of a desired calling number, which the user desires to display on the called terminal 108, and the phone number of the called terminal 108. For example, the user may input “*1004#0162572219”. Herein, “*” is a first delimiter for representing the beginning of an input of the desired calling number, and “#” is a second delimiter for representing the completion of the input of the desired calling number. Also, the calling terminal 100 recognizes the number input after the input of the second delimiter “#” as the phone number of the called terminal 108.

When the calling terminal 100 transmits the origination message including the number inputted by its user in step 302, the mobile switching center 104 receives the origination message and determines if the origination message includes a number for the calling number change service. Herein, the calling number change service is defined as a service for displaying a calling number desired by a caller on the called terminal 108.

When it is determined in step 304 that the origination message includes a number for the calling number change service, the process continues to step 308. In step 308, the mobile switching center 104 records the desired calling number received from the calling terminal 100 into a record field, thereby generating an alert message. That is, when the mobile switching center 104 recognizes number “*1004#0162572219” through a parsing process of the origination message received from the calling terminal 100, the mobile switching center 104 determines that the calling terminal 100 requests the calling number change service. After this, the mobile switching center 104 generates an alert message by recording the desired calling number “1004” in the record field of the alert message, and then transmits the alert message to the called terminal 108 having a phone number of “0162572219” (step 310). At this time, the transmitted alert message may includes both of the desired calling number “1004” input the user of the calling terminal 100 and the phone number of the called terminal 108.

After this, the called terminal 108 receives the alert message and displays the desired calling number included in the alert message. When the desired calling number “1004” input by the user of the calling terminal 100 and the phone number of the called terminal 108 are together transmitted, the called terminal 108 displays both of the desired calling number input by the user of the calling terminal 108 and the phone number of the called terminal 108. After this, a user of the called terminal 108 checks the caller information displayed on the terminal and then determines whether or not he/she will respond to the call. When the user of the called terminal 108 responds to the call, communication is realized between the caller and a called subscriber.

While the present invention has been described as a processing method for displaying a calling number desired by a user of a calling party, it should be understood that it is possible to transmit a character string or an image as well as the desired calling number.

In more detailed description, for example, when an input calling number is not a phone number but a numeral “0”, that is, when a user of the calling terminal 100 inputs “*0#0165306601” and pushes the call key, the calling terminal 100 transmits the input number to the mobile switching center. Then, the mobile switching center receives the input number, and transmits a character string or an image, which has been stored corresponding to the numeral “0”, to a called terminal 108 having the phone number of “0165306601”. In this case, it goes without saying that a character string or an image corresponding to the numeral “0” has to be preset by a service provider. When it is defined that the numeral “0” corresponds to a sentence “How are you?”, a mobile switching center in the CDMA system records the sentence “How are you?” in a calling party record field of an alert message, and then transmits the alert message to the called terminal 108.

With the WCDMA system, when a user of the calling terminal 100 inputs “*0#0165306601” and pushes the call key, the calling terminal 100 records “*0#” in an optional field of a setup message, and then transmits the setup message to the mobile switching center. Then, the mobile switching center receives the setup message, records the sentence “How are you?” stored corresponding to the numeral “0” in a facility field of the setup message, records a calling number of the calling party in a calling party BCD number field, and then transmits the setup message. Then, a called terminal 108 receiving the setup message displays the sentence “How are you?” together with the calling number of the calling party.

Hereinafter, a method for displaying a desired calling number, which is desired by a user of a calling terminal 108, on a called terminal 108 in a WCDMA mobile communication system will be described with reference to FIG. 4.

First, when a user of the calling terminal 100 inputs a phone number and pushes a call key for communication, the calling terminal 100 determines if the input number includes a request for the calling number change service (step 400). Such a determination of the request for the calling number change service is achieved by determining if the phone number input by the user of the calling terminal 100 includes the first delimiter “*” for representing the beginning of an input of the desired calling number, the second delimiter “#” for representing the completion of the input of the desired calling number, and a phone number of a called terminal 108 following the second delimiter “#”.

When the input does not request the calling number change service, that is, when only a phone number of the called terminal 108 is input, a process for setting up a normal call is performed.

As a result of the determination in step 400, when the input is a request the calling number change service, that is, the input includes the first delimiter “*” for representing the beginning of an input of the desired calling number, the second delimiter “#” for representing the completion of the input of the desired calling number, and the desired calling number, the calling terminal 100 records the input calling number in an optional field of a setup message.

After this, the calling terminal 100 transmits the setup message (step 404). Then, the mobile switching center 104 receives the setup message, and determines if the received setup message includes a number for the calling number change service. If the setup message includes a desired calling number as a result of parsing the setup message, step 410 is proceeded, and if not, step 408 is proceeded to perform a normal call set up process.

When a process is proceeded from step 406 to step 410, the mobile switching center 104 records a calling party BCD number, that is, the desired calling number input by the user of the calling terminal 100, in the setup message. After this, the mobile switching center 104 transmits the setup message to the called terminal 108 (step 412). At this time, the transmitted setup message may include both the desired calling number “1004” input by the user of the calling terminal 100 and the phone number of the calling terminal 100.

Then, the called terminal 108 receives the setup message and displays the calling party BCD number. In the case in which the desired calling number “1004” input by the user of the calling terminal 100 is transmitted together with the phone number of the calling terminal 108, the called terminal 108 displays both of them. After this, the user of the called party checks caller information displayed on the called terminal 108, and then determines whether or not he will respond to the call. When the user of the called terminal 100 responds to the call, communication is realized between the caller and a called subscriber.

As described above, a system and a method according to the present invention enables a calling number desired by a user of a calling terminal to be displayed on a called terminal when the calling number is displayed on the called terminal.

Therefore, a system and a method according to the present invention have an advantage in that a calling number desired by a user of a calling terminal can be displayed on a called terminal when the user of calling terminal originates a call.

While the present invention has been shown and described with reference to certain preferred embodiments thereof, it will be understood by those skilled in the art that various changes in form and details may be made therein without departing from the spirit and scope of the invention as defined by the appended claims. For example, while the present invention has been described as embodiments for displaying a calling number desired by a user of a calling terminal on a called terminal, it can be understood that it is possible to display a character string or an image concluded by service providers on the called terminal, instead of the desired calling number. Accordingly, the scope of the invention is not to be limited by the above embodiments but by the claims and the equivalents thereof.

1. A mobile communication system comprising:
a calling terminal for transmitting an origination message which includes a phone number of a called terminal and a specific number input by a user of the calling terminal; and
a mobile switching center for determining if the origination message includes the specific number when the origination message is received, sensing the specific number when the origination message includes the specific number, creating an alert message which includes a message corresponding to the specific number, and transmitting the alert message to the called terminal;
wherein the called terminal displays the message included in the alert message when the alert message is received.

2. The system as claimed in claim 1, wherein, when the mobile switching center receives the origination message, the mobile switching center parses the origination message to determining if the origination message includes a first delimiter for representing the beginning of an input of the specific number and a second delimiter for representing the completion of the input of the specific number.

3. The system as claimed in claim 1, wherein, when the specific number included in the origination message is a calling number desired to be displayed on the called terminal, the mobile switching center creates the alert message which includes the calling number received from the calling terminal in a record field of the alert message.

4. The system as claimed in claim 1, wherein, when the specific number included in the origination message is a number for displaying a character string or an image, the mobile switching center creates the alert message which includes the character string or the image corresponding to the specific number.

5. The system as claimed in claim 1, wherein, the mobile communication system is a CDMA system.

6. A mobile communication system comprising:
a calling terminal for determining if a specific number is included in data input by a user when the user inputs a phone number and pushes a call key, and transmitting a first setup message which includes in an optional field of the first setup message the specific number input by the user when the specific number is included in the data input by the user; and
a mobile switching center for receiving the first setup message, sensing the specific number when the first setup message includes the specific number, creating a second setup message which includes a message corresponding to the specific number, and transmitting the second setup message to the called terminal;
wherein the called terminal displays the message included in the second setup message when the second setup message is received.

7. The system as claimed in claim 6, wherein, when the user inputs the phone number and pushes the call key, the calling terminal records the specific number in the optional field of the first setup message and transmits the first setup message if the user's input includes a first delimiter for representing the beginning of an input of the specific number, the specific number, and a second delimiter for representing the completion of the input of the specific number.

8. The system as claimed in claim 6, wherein, when the mobile switching center receives the first setup message, the mobile switching center parses the first setup message to determine if the first setup message includes a first delimiter for representing the beginning of an input of the specific number and a second delimiter for representing the completion of the input of the specific number.

9. The system as claimed in claim 6, wherein, when the specific number included in the first setup message is a calling number desired to be displayed on the called terminal, the mobile switching center creates the second setup message which includes the calling number received from the calling terminal.

10. The system as claimed in claim 6, wherein, when the specific number included in the first setup message is a number for displaying one of a character string or an image, the mobile switching center creates the second setup message which includes the character string or the image corresponding to the specific number.

11. The system as claimed in claim 6, wherein, the mobile communication system is a WCDMA system.

12. A method for displaying a calling number in a mobile communication system which includes a calling terminal, a mobile switching center, and a called terminal, the method comprising the steps of:
transmitting, from the calling terminal, an origination message to the mobile switching center, the origination message including a phone number of the called terminal and a specific number input by its user;
determining, in the mobile switching center, if the origination message includes the specific number when the origination message is received, sensing the specific number when the origination message includes the specific number for requesting a calling number change service, creating an alert message which includes a message corresponding to the specific number, and transmitting the alert message to the called terminal; and
displaying, in the called terminal, the message included in the alert message when the alert message is received.

13. The method as claimed in claim 12, wherein, the mobile switching center parses the origination message and determines if the origination message includes a first delimiter for representing the beginning of an input of the specific number for the calling number change service, the specific number, and a second delimiter for representing the completion of the input of the specific number, so as to determine if the origination message includes the specific number.

14. The method as claimed in claim 12, further comprising a step of causing, in the mobile switching center, a calling number received from the calling terminal to be included in a record field of the alert message to be created, when the specific number included in the origination message is the calling number desired to be displayed on the called terminal.

15. The method as claimed in claim 12, further comprising a step of creating, in the mobile switching center, an alert message which includes an image or a character string corresponding to the specific number, when the specific number included in the origination message is a number for displaying one of the image and the character string.

16. The method as claimed in claim 12, wherein, the mobile communication system is a CDMA system.

17. A method for displaying a calling number in a mobile communication system which includes a calling terminal, a mobile switching center, and a called terminal, the method comprising the steps of:
determining, in the calling terminal, if a specific number is included in data inputted by a user when the user inputs a phone number and pushes a call key, recording the specific number input by the user in an optional field of a first setup message when the specific number is included in the data input by the user, and transmitting the first setup message to the mobile switching center;
receiving, in the mobile switching center, the first setup message, sensing the specific number when the first setup message includes the specific number, creating a second setup message which includes a message corresponding to the specific number, and transmitting the second setup message to the called terminal; and
displaying, on the called terminal, the message included in the second setup message when the second setup message is received.

18. The method as claimed in claim 17, wherein, when the user inputs the phone number and pushes the call key, the calling terminal determine if the phone number input by its user includes a first delimiter for representing the beginning of an input of the specific number, the specific number, and a second delimiter for representing the completion of the input of the specific number, so as to determine if the specific number is input.

19. The method as claimed in claim 17, further comprising a step of causing, in the mobile switching center, a calling number received from the calling terminal to be included in the second setup message to be created, when the specific number included in the first setup message is the calling number desired to be displayed on the called terminal.

20. The method as claimed in claim 17, further comprising a step of causing, in the mobile switching center, an image or a character string corresponding to the specific number to be included in the second setup message to be created, when the specific number included in the first setup message is a number for displaying one of the image and the character string.

21. The method as claimed in claim 17, wherein, the mobile communication system is a WCDMA system.
